(19) United States
(12) Patent Application Publication
(10) Pub. No.: US 2002/0048998 A1
(43) Pub. Date: Apr. 25, 2002

(54) Power adapter for use in aircraft

(76) Inventor: Manfred Fladung, Mombris (DE)

Correspondence Address: DENNISON, SCHEINER SCHULTZ & WAKEMAN, 612 CRYSTAL SQUARE FOUR, 1745 JEFFERSON DAVIS HIGHWAY, ARLINGTON, VA, 22202-3417, US

(21) Appl. No.: 09/796,726

(22) Filed: Mar. 2, 2001

(30) Foreign Application Priority Data
Mar. 3, 2000 (DE) 200 03 907.5

(51) Int. Cl. H01R 25/00

(52) U.S. Cl. 439/651

(57) ABSTRACT

The invention relates to an adapter for a connector in an aircraft power supply system that is designed to permit the supply of power onboard aircraft, comprising pins (16, 18, 20) that are positioned in the aircraft, especially extending outward from a base plate (22), onto which sockets of the adapter may be pushed. In order to enable the rapid replacement or repair in the case of damage to a pin, it is proposed that an exchangeable adapter (24) be positioned on and fastened to the pins (16, 18, 20) in the aircraft, and that the adapter be comprised of a receptacle base (38) with contact elements (26, 28, 36), which are designed, in the area nearest the pins, at one end as sleeves or sockets designed to take up the pins, and at the other end to extend beyond the receptacle base and correspond dimensionally to the pins.

The invention relates to an adapter for a connector in an aircraft power supply system that is designed to permit the supply of power onboard aircraft, comprising pins that extend outward from a base plate mounted to the aircraft, to which sockets of the adapter can be connected.

For the supply of power onboard aircraft, multicore cables with connectors are used, which are plugged into a receptacle that is positioned in the aircraft, and contains contact pins. Via the cable and the connector, preferably 200 V to 112 V/400 Hz supply voltage and direct voltage (28 V) for check-back signals are transmitted.

One connector used for power supply systems is known from EP 0 236 923 B1, in which the shell is designed to have several parts, and the contact elements themselves are designed to be interchangeable. In this way, damaged contacts can be replaced within the shortest possible time, without requiring replacement of the entire connector, which would require long periods of power outage.

With the receptacles it must be noted that, especially when the connector is not pushed properly onto the pins, current flows through the developing contact resistance, which results in the formation of heat which can result in destruction or damage to the pins. When this occurs it becomes necessary to replace the entire receptacle, in other words the base plate and the pins extending therefrom. This process requires a considerable amount of time, during which the aircraft cannot be flown.

In addition to receptacles intended specifically for use in aircraft, a multitude of other connectors are also known in the art.

For instance, U.S. Pat. No. 3,503,035 relates to a two-part connector socket with receptacle plates, in which rotatable contacts are positioned.

One electrical connector for small appliances such as coffee grinders or small mixers is known from DE-GM 19 20 069. The small appliance is equipped with an electrical plug, via which the device can be connected to a socket.

In EP 0 907 227 A2, an electrical power connector with electronic circuitry is described.

EP 05 07 682 A 2 relates to a electrical power connector having circuitry via which contacts are interconnected.

An electrical connector that can be assembled from two halves is known from DE 30 42 293 C2; with this design, worn or damaged parts can be easily replaced.

The object of the present invention is to provide an adapter of the type described above, such that even if the pins taken up in the connector become damaged, they can be replaced or repaired quickly.

To this end, the invention essentially provides that an exchangeable adapter can be positioned on and fastened to the pins, which are mounted in the aircraft, and that the adapter is equipped with a receptacle base having contact elements which, on the side nearest the pins, are designed at one end as a sleeve or socket into which the pins are inserted, and at the other end are designed to extend beyond the receptacle base and to correspond dimensionally to the pins. Further, the contact elements themselves are positioned in the receptacle base such that they can be removed; thus if only one contact element should become damaged, only that one need be replaced. It is also possible for the receptacle base itself, which is made of plastic, to be replaced should it become damaged, while the contact elements can continue to be used.

The sleeve-shaped end sections of the contact elements of the adapter, which are designed to take up the pins that extend outward from the aircraft, are positioned entirely or almost entirely inside the receptacle base, with the front rims of the sleeve-shaped end sections being in alignment with, or nearly in alignment with, the surface of the receptacle base, which faces the aircraft. Further, when the adapter has been pushed onto the pins that extend outward from the aircraft, the surface of the receptacle base that is facing the aircraft lies flat against or nearly flat against the base plate.

In order to exclude the possibility of an uncontrolled separation of the adapter from the pins positioned in the aircraft, the base may be fastened to the pins, for example, using an eccentric clamping element. It is also possible for locking elements, preferably made of metal, to extend outward from the receptacle base, which would work in conjunction with the receptacle base to secure it on or in the aircraft. In accordance with a further proposal, the receptacle base may be equipped with a slit that extends over its entire length and parallel to the contact elements, and can be closed via at least one screw element. The receptacle base may also be bolted to the aircraft or to the base plate, which also permits a secure fastening of the adapter to the pins while allowing easy replacement.

Further details, advantages, and characteristics of the invention are to be found not only in the claims, in the characteristics found therein, alone and/or in combination, but also in the following description of one preferred exemplary embodiment, which is illustrated in the diagrams.

These show:

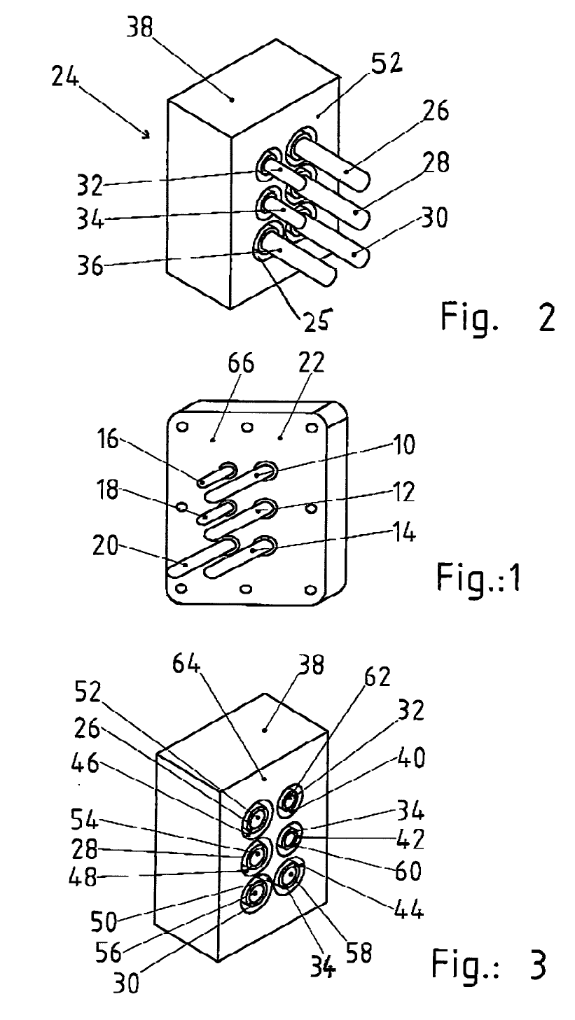

FIG. 1 a base plate mounted to an aircraft, with contact pins extending from the base plate

FIG. 2 a perspective illustration of an adapter that may be placed on the contact pins as illustrated in FIG. 1

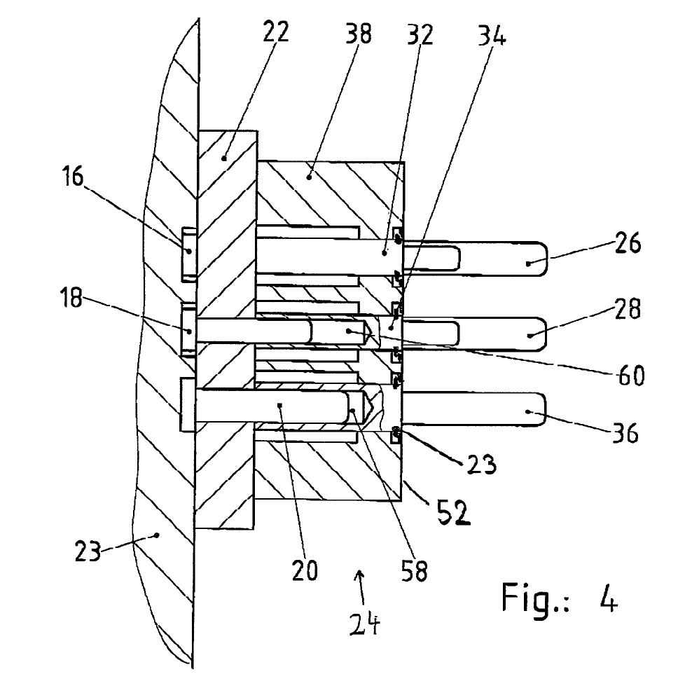

FIG. 3 a rear view of the adapter shown in FIG. 2, and

FIG. 4 a cross-section of an adapter that is fastened to a mounting plate.

In order to supply an aircraft with electrical power or to permit the transmission of signals, couplers or connectors, which are connected to a power supply via a cable, are pushed onto contact pins that extend outward from the aircraft; these pins are positioned in a receptacle in the aircraft that can be closed off with a plate. To this end, contact pins, which in FIG. 1 are indicated by the numbers 10, 12, 14, 16, 18, and 20, usually extend outward from a plate 22 designed as a base, which is then bolted to the aircraft. The backs of the contact pins 10, 12, 14, 16, 18, and 20 are connected to cables, in order to ensure the desired current or signal transmission. If a contact pin should become damaged or destroyed, as a result, for example, of overheating caused by the adapter not being properly fitted onto the contact pins, then not only must all of the contact pins, together with the base plate, be removed from the aircraft, but the cables extending from the back of the base plate must also be removed. This process is costly and requires a considerable amount of time, during which the aircraft may not be flown.

In order to avoid these disadvantages, an adapter 24 is provided in accordance with the invention, wherein the number of contact elements 26, 28, 30, 32, 34, 36 provided in the adapter corresponds to the number of contact pins 10, 12, 14, 16, 18, 20. The contact elements 26, 28, 30, 32, 34, 36 extend outward from a rectangular receptacle base 38, which is equipped with through borings 40, 42, 44, 46, 48, 50, in which the contact elements 26, 28, 30, 32, 34, 36 are positioned such that they can be removed. In this, the contact elements, 26, 28, 30, 32, 34, 36 may be secured via suitable securing rings such as Seeger circlip rings 23, which may be positioned in a corresponding depression 25 in the front surface 52 of the receptacle base 38.

The contact elements 26, 28, 30, 32, 34, 36 are designed at one end as sleeve elements, the inner geometry of which is designed to hold the pins 10, 12, 14, 16, 18, 20 in a precise fit. The corresponding sections of the contact elements 26, 28, 30, 32, 34, 36 are indicated in FIG. 3 with the numbers 52, 54, 56, 58, 60, 62. The sleeve-shaped sections 52, 54, 56, 58, 60, 62 extend inside the receptacle base 38, with their front rims being in alignment with, or essentially in alignment with, the lower ends of the contact pins 10, 12, 14, 16, 18, 20, and thus with the surface 64 that faces the base plate 22.

The contact elements 26, 28, 30, 32, 34, 36 which extend beyond the front surface 52, in the area that is beyond the surface 52 and faces away from the aircraft, correspond in shape to the geometry of the contact pins 10, 12, 14, 16, 18, 20, hence adapters can be easily pushed onto the pin-shaped sections of the contact elements 26, 28, 30, 32, 32 [sic], 34, 36, thus securing the desired current and signal transmission.

When the adapter 24 has been positioned on the pins 10, 12, 14, 16, 18, 20, the surface 61 of the adapter that faces the aircraft lies flat or essentially flat against the front surface 66 of the base plate 22, which is mounted directly to the aircraft.

In order to exclude the possibility of an unintended separation of the adapter 24 from the pins 10, 12, 14, 16, 18, 20, the receptacle base 38 may be bolted to the base plate 22, as is indicated purely in principle in the cross-section illustrated in FIG. 4. It is also possible, however, for the receptacle base 38 to be equipped with a slit that extends parallel to the contact elements 26, 28, 30, 32, 34, 36 and that is closed via some sort of fastening element such as a screw element, when the receptacle base, in other words the sleeve-shaped sections 52, 54, 56, 58, 60, 62, has been pushed onto the pins 10, 12, 14, 16, 18, 20. By closing the slit, the receptacle base 38 becomes clamped to the pins 10, 12, 14, 16, 18, 20, making it immovable.

It is also possible for an eccentric clamp to be provided, in order to brace the receptacle 24 in relation to the pins 10, 12, 14, 16, 18, 20. A further possibility for securing the receptacle base 38 and thereby the adapter 24 can be achieved by providing hook-shaped elements, such as metal elements, to extend outward from the receptacle base 38, which then act in conjunction with the aircraft or with a recessed area in the aircraft. In order to remove the adapter, the corresponding mounting elements must then be bent or removed.

If one of the pins 26, 28, 30, 32, 34, 36 that extends from the adapter 24 should become damaged and need to be replaced, it is now necessary only for the adapter 24 to be pulled off of the pins 10, 12, 14, 16, 18, 20 that extend outward from the base plate 22, in order to effect replacement. The damaged adapter or only those contact elements 36 [sic], 28, 30, 32, 34, 36 that are no longer functioning may be replaced. This requires only a short period of time, so that functional contact pins may be quickly readied for connection with a coupler, so that the aircraft is again ready for use.

1. Adapter for a connector in an aircraft power supply system that is designed to permit the supply of power onboard aircraft, comprising pins (10, 12, 14, 16, 18, 20) that extend outward from a base plate (22) mounted to the aircraft, to which sockets of the adapter may be connected, characterized in that an exchangeable adapter (24) may be connected and fastened to the pins (10, 12, 14, 16, 18, 20) that extend outward from the aircraft, and in that the adapter comprises a receptacle base (38) with contact elements (26, 28, 30, 32, 34, 36) that are designed, at the end nearest the pins, as sleeves or sockets (52, 54, 56, 58, 60) designed to receive the pins and at the other end are designed to extend beyond the receptacle base and to correspond dimensionally to the pins (10, 12, 14, 16, 18, 20).

2. Adapter in accordance with claim 1, characterized in that the contact elements (26, 28, 30, 32, 34, 36) are connected to the receptacle base (38) such that they can be removed.

3. Adapter in accordance with claim 1, characterized in that the receptacle base (38) is rectangular in shape, with through borings (40, 42, 44, 46, 48, 50) that extend parallel to one another, to receive the contact elements (26, 28, 30, 32, 34, 36).

4. Adapter in accordance with claim 1, characterized in that the contact elements (26, 28, 30, 32, 34, 36) are fastened via a securing ring (23) to the receptacle base (38) such that they can be replaced.

5. Adapter in accordance with claim 1, characterized in that the sleeve- or socket-shaped end sections (52, 54, 56, 58, 60, 62) of the contact elements (26, 28, 30, 32, 34, 36) extend entirely or nearly entirely inside the receptacle base (38).

6. Adapter in accordance with claim 1, characterized in that the sleeve- or socket-shaped end section (52, 54, 56, 58, 60, 62) of the contact elements (26, 28, 30, 32, 34, 36) extend in alignment or nearly in alignment with the base surface (64) of the receptacle base (38) that faces the aircraft.

7. Adapter in accordance with claim 1, characterized in that, when the adapter (24) has been positioned on the pins (10, 12, 14, 16, 18, 20) that extend outward from the aircraft, the base surface (64) of the receptacle base (38), which faces the aircraft, lies flat against, or nearly flat against, the base, such as the base plate (22).

8. Adapter in accordance with claim 1, characterized in that the receptacle base (38) is mounted to the pins (10, 12, 14, 16, 18, 20) that extend outward from the aircraft, or to the base plate (22), via an eccentric clamping element.

9. Adapter in accordance with claim 1, characterized in that a fastening element, preferably made of metal, extends outward from the receptacle base (38), and works in conjunction with the receptacle base (38) to secure it on or in the aircraft.

10. Adapter in accordance with claim 1, characterized in that the receptacle base (38) is equipped with a slit that extends over its entire length, parallel to the contact elements (26, 28, 30, 32, 34, 36), and can be clamped or closed via a screw element in order to fasten the adapter (24) to the pins (10, 12 14, 16, 18, 20) or to the base plate (22).

11. Adapter in accordance with claim 1, characterized in that the receptacle base (38) can be bolted to the aircraft or to the base plate (22) that holds the pins (10, 12, 14, 16, 18, 20).
